(19) United States
(12) Patent Application Publication
(10) Pub. No.: US 2011/0187074 A1
(43) Pub. Date: Aug. 4, 2011

(54) PROPULSION APPARATUS

(76) Inventor: Andrew Malloy, Berkhamsted (GB)

(21) Appl. No.: 12/445,736

(22) PCT Filed: Oct. 16, 2005
(86) PCT No.: PCT/GB07/03916

§ 371 Date: Oct. 25, 2010

(30) Foreign Application Priority Data
Oct. 16, 2006 (GB) 0620477.0

(51) Int. Cl. B62M 1/16; A61G 5/02

(52) U.S. Cl. 280/244

(57) ABSTRACT

Propulsion apparatus which is mountable to the wheel (3) of a vehicle, and in particular a wheelchair, the apparatus comprising a wheel adapter assembly (1) which comprises a plurality of pivotable spoke assemblies (5) which are engageable with the rim (4) of the wheel, and a brake and drive arrangement (72) which comprises selectively engageable clutch arrangement which allows a user, by way of a lever arm portion (71), to propel the vehicle.

The present invention relates to propulsion apparatus, and in particular, although not exclusively, to propulsion apparatus for wheelchairs.

The present invention relates generally to propulsion apparatus of the type which is mountable to a vehicle, the vehicle comprising at least one ground engaging wheel having an axis of rotation and the propulsion apparatus comprising a first portion adapted to be statically attached at a location remoter from said axis to either a rim of said wheel or to a structural member projecting from a plane defined by said wheel, the structural member being rigidly attached to the wheel, a second portion pivotal about the rotational axis, and coupling means which on pivotal movement of said second portion causes the first portion to rotate to thereby propel the vehicle, and the first portion is provided with means for location of said second portion such that the axis of rotation of the second portion is coincident with the axis of wheel.

The first portion may be adapted to be detachable from the wheel, or alternatively may be integral with the wheel.

The second portion is preferably adapted to be detachable from the first portion. However the second portion may be integral with the first portion.

The second portion preferably comprises a lever arm.

Preferably the first portion is statically attached to said wheel by a plurality of attachment spoke members.

The first portion preferably comprises a hub portion.

A clutch mechanism is preferably such that there are no control cables through a lever arm of the second portion.

Advantageously a user can preferably adjust working length of the lever arm during use.

According to a first aspect of the invention there is provided a wheel adapter assembly comprising attachment means for attachment to a wheel or structure projecting from the wheel the attachment means comprising a pivotable spoke assembly which is pivotable about an axis substantially perpendicular to the axis of rotation of the adapter assembly when secured to the wheel and further comprising locking means to a hold the spoke assembly substantially rigid with a hub portion.

The spoke assembly is preferably capable of being moved from a radially retracted condition to a radially extended condition and vice versa. A plurality of angularly spaced spoke assemblies is preferably provided.

Another aspect of the invention relates to a drive and brake arrangement for a propulsion apparatus, the arrangement comprising clutch means which allows selective engagement of roller clutch means; in a first selected condition the roller clutch means transmits an input torque of a first rotational sense to an output drive portion and does not transmit an input torque of an opposite rotational sense to the output drive portion, and in a second selected condition the clutch means is disengaged.

Preferably clutch engagement means is arranged to be translated in a substantially axial direction.

Preferably brake means is adapted to be translated in a substantially axial direction.

A third aspect of the invention relates to a lever arm assembly of a propulsion apparatus, the assembly comprising a weighted portion which, in use, acts to self-right the lever arm to a desired orientation.

Further aspects of the invention relate to propulsion apparatus comprising at least one of the first, second and third aspects of the invention.

We may provide a variable drive ratio by way of a lever arm of variable working length.

Braking arrangement comprising a braking surface moveable between an engaged condition and a disengaged condition.

One embodiment of the invention will now be described, by way of example only, with reference to the accompanying drawings in which;

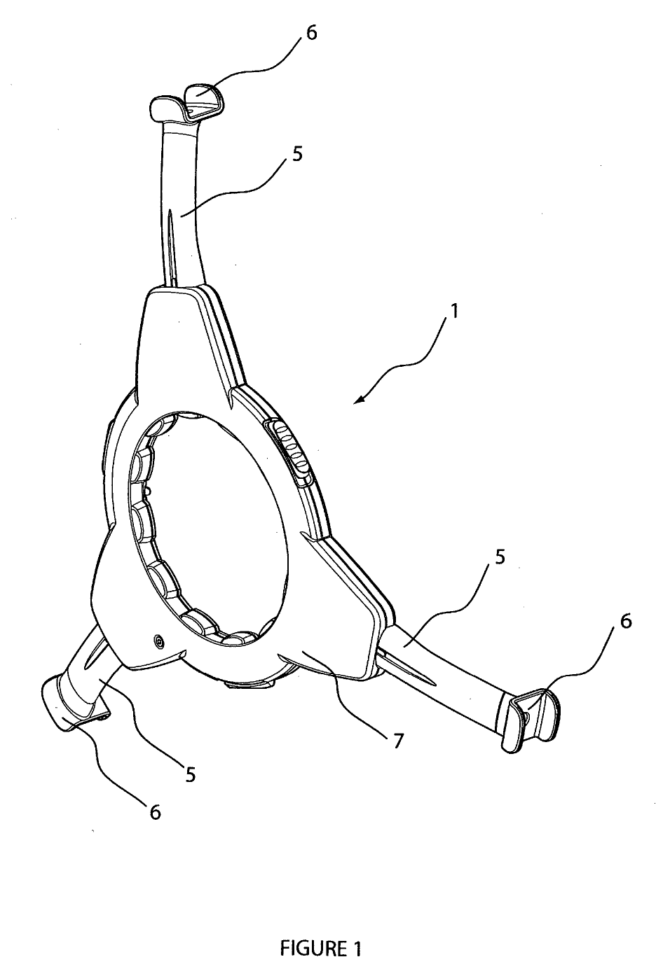

FIG. 1 is a perspective view of a wheel adapter,

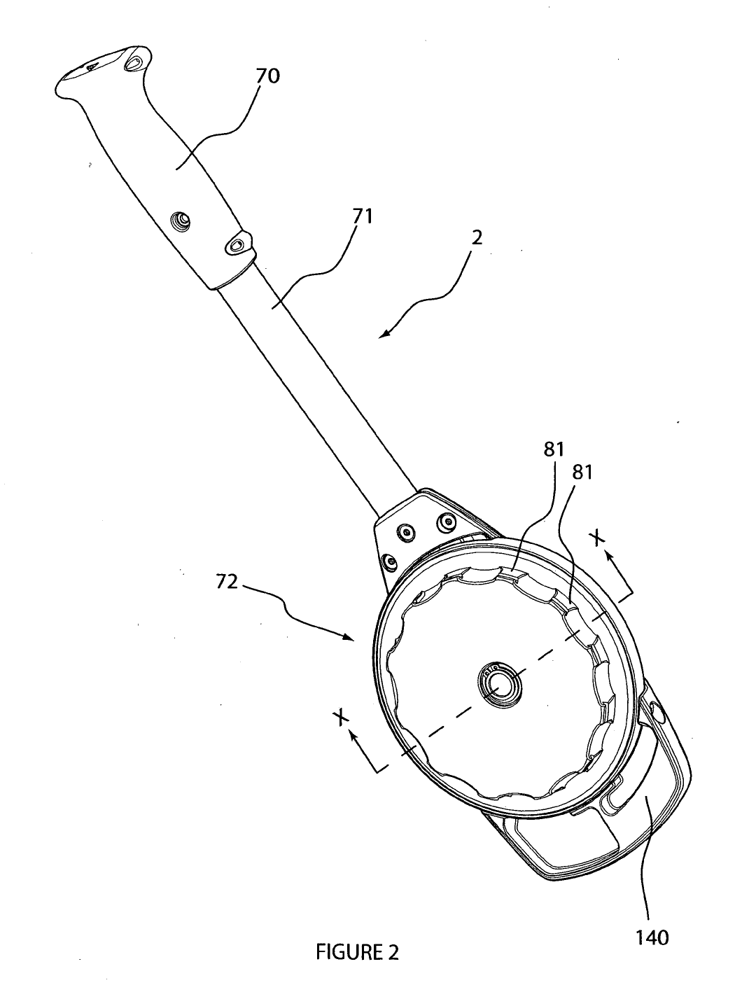

FIG. 2 is a perspective view of a lever arm assembly,

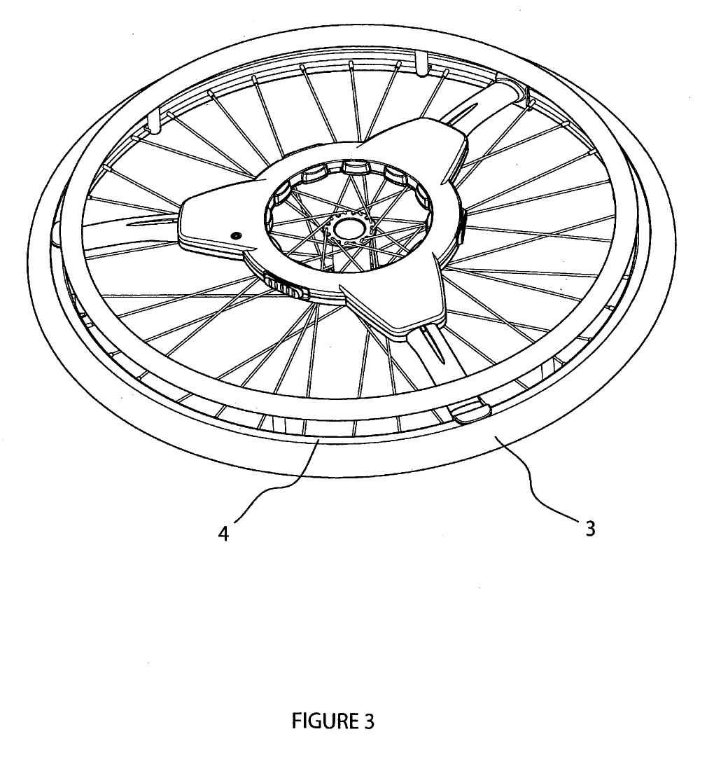

FIG. 3 is a perspective view of the wheel adapter of FIG. 1 attached to a wheelchair wheel,

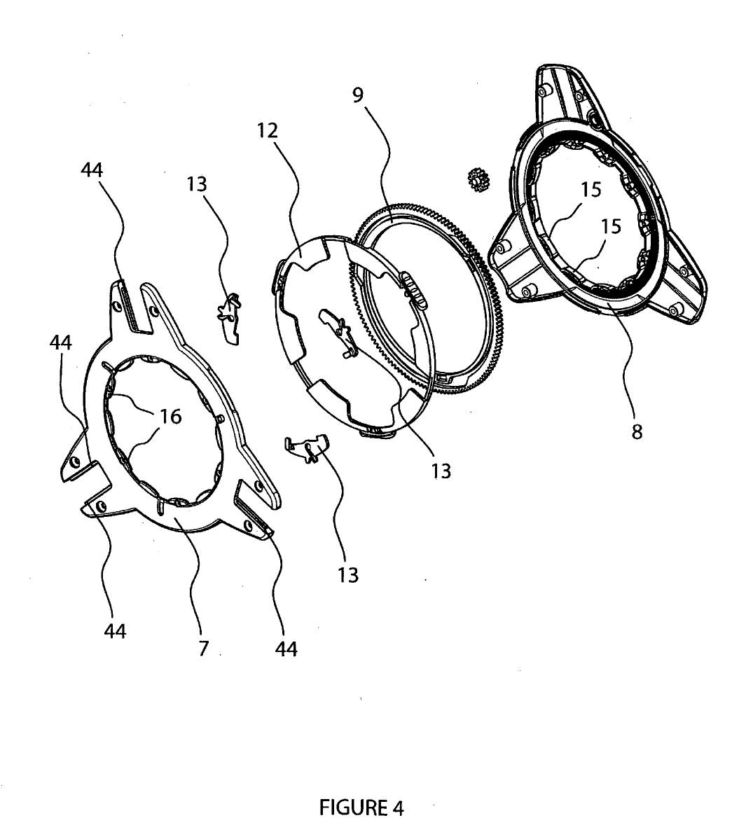

FIG. 4 is an exploded perspective view of various components of the wheel adapter assembly,

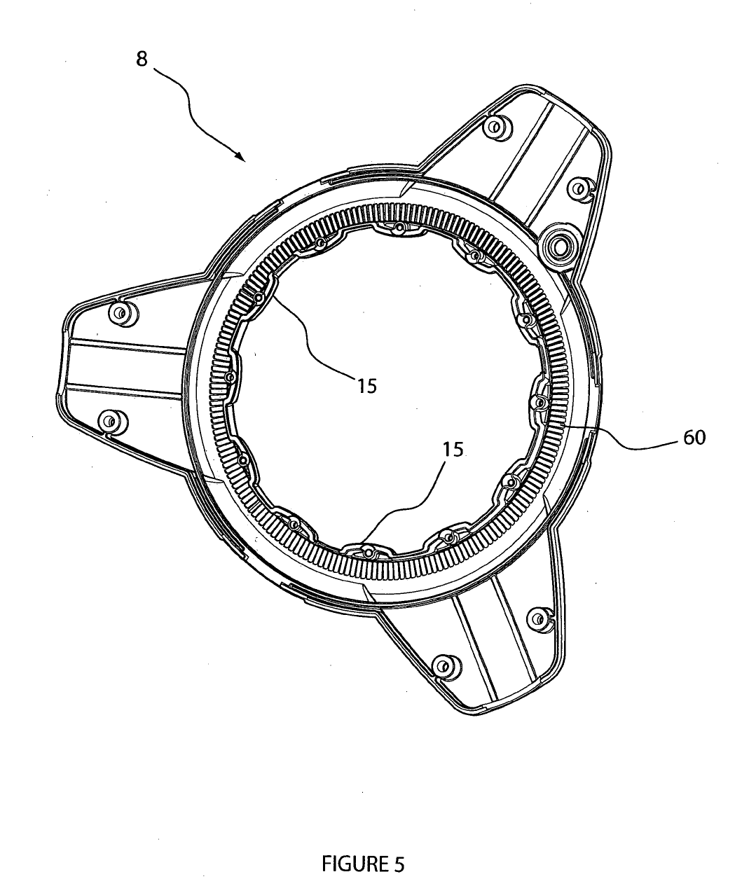

FIG. 5 is plan view of an outer housing of the wheel adapter assembly

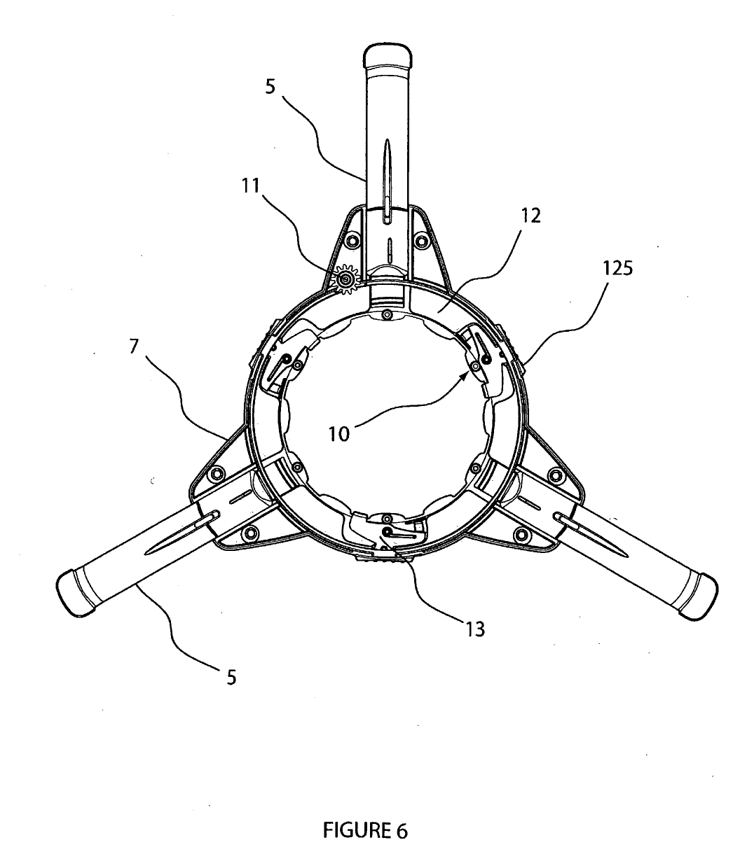

FIG. 6 is a plan view of various components of the wheel adapter assembly,

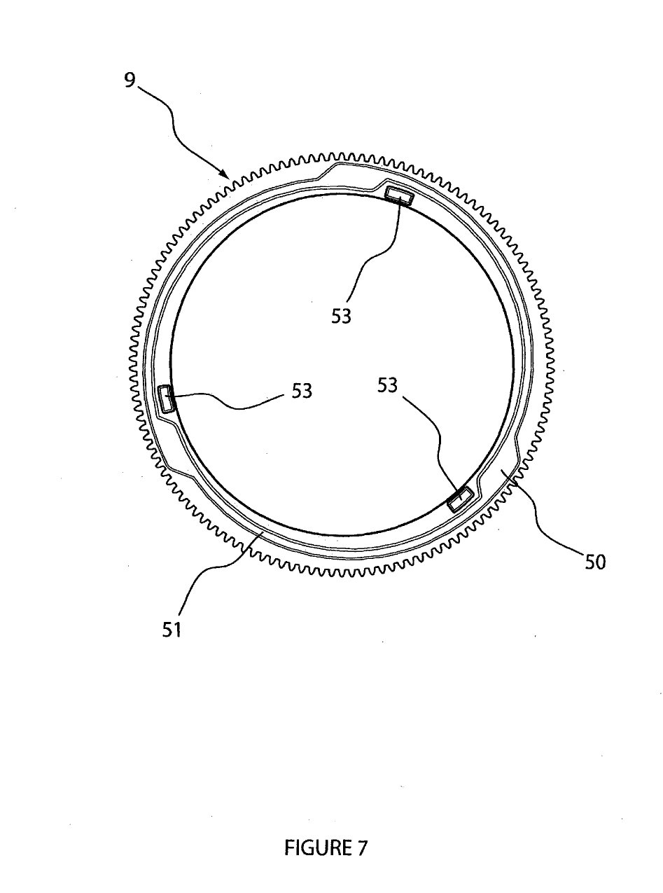

FIG. 7 is a plan view of a first side of a cam ring of the wheel adapter assembly,

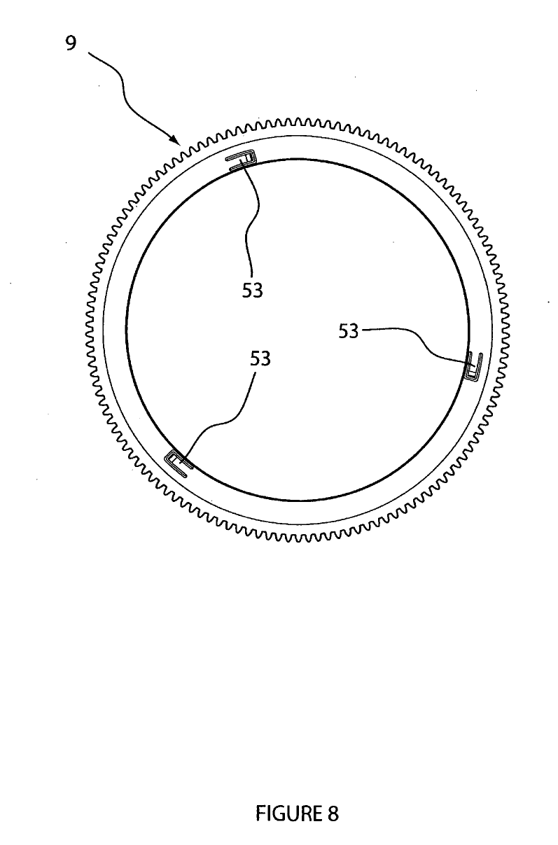

FIG. 8 is a plan view of an opposite side of the cam ring of FIG. 7,

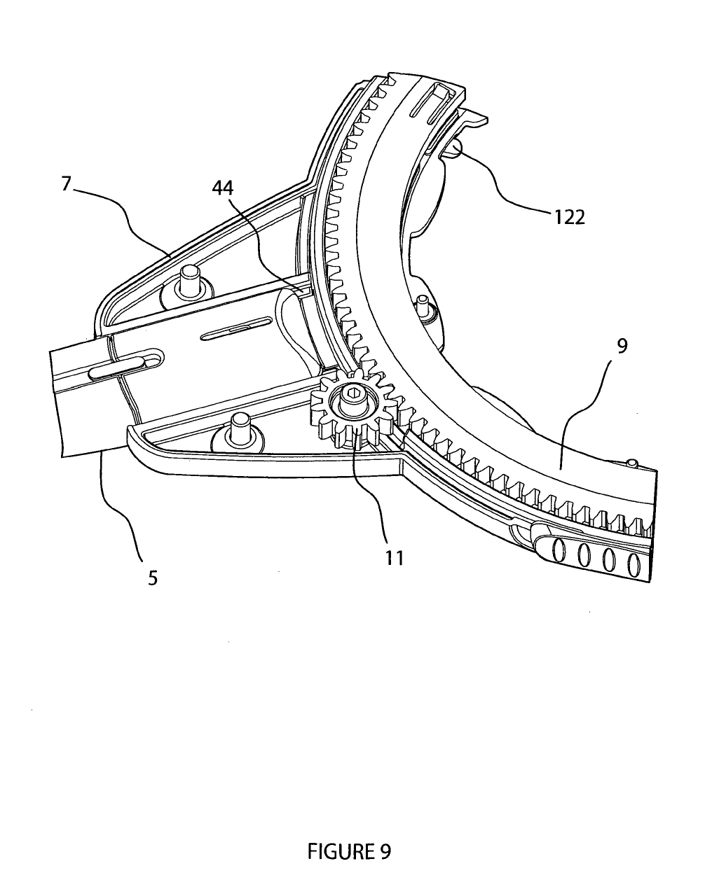

FIG. 9 is a first partial perspective view of the wheel adapter,

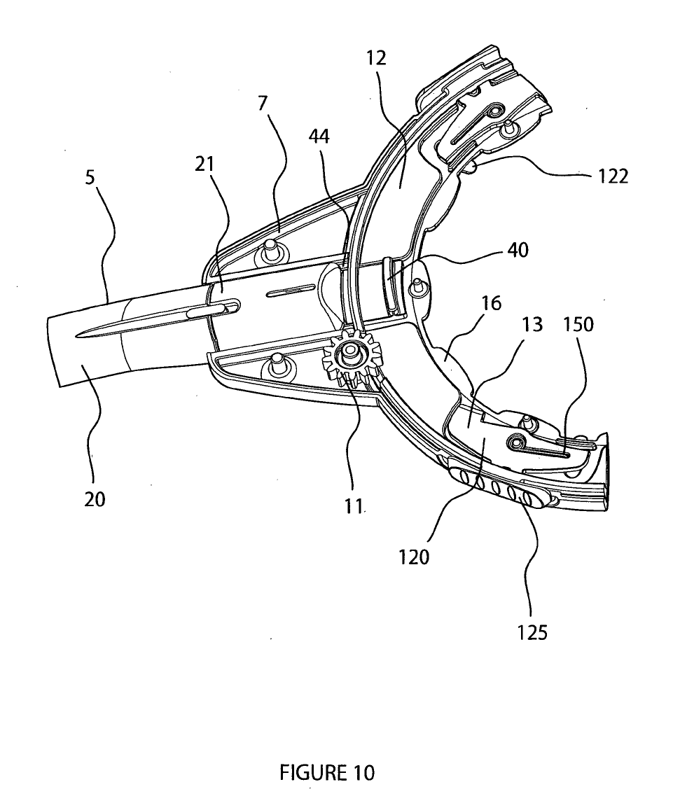

FIG. 10 is a second partial perspective view of the wheel adapter,

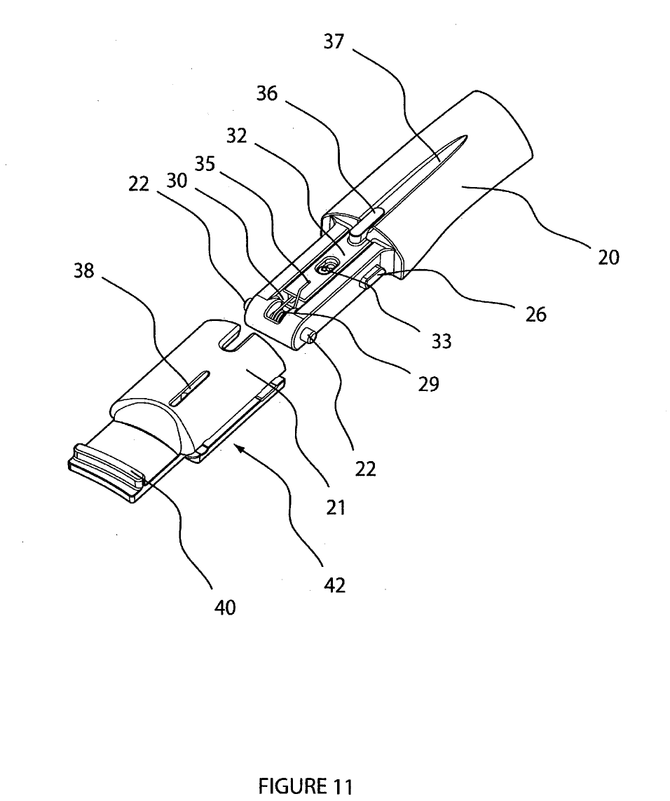

FIG. 11 is a top perspective view of a spoke assembly of the wheel adapter,

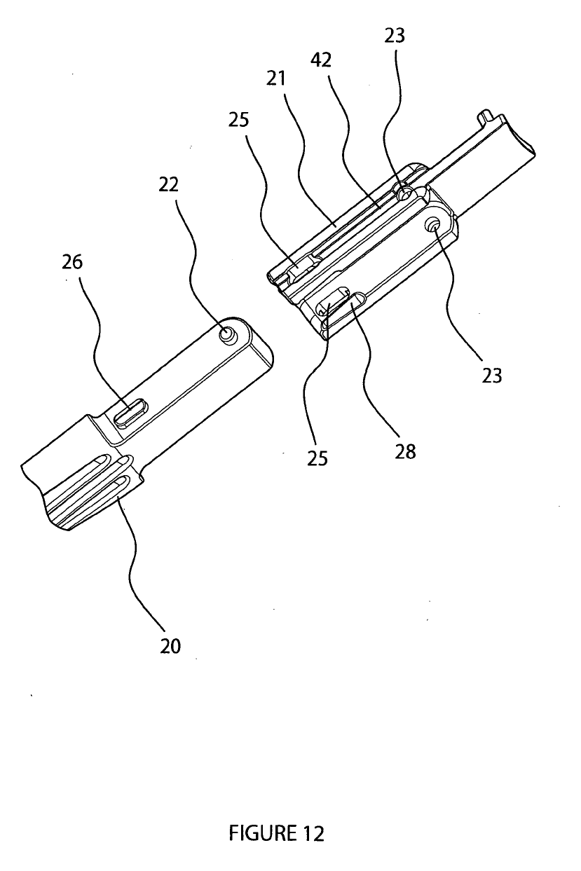

FIG. 12 is lower perspective view of the spoke assembly of FIG. 11,

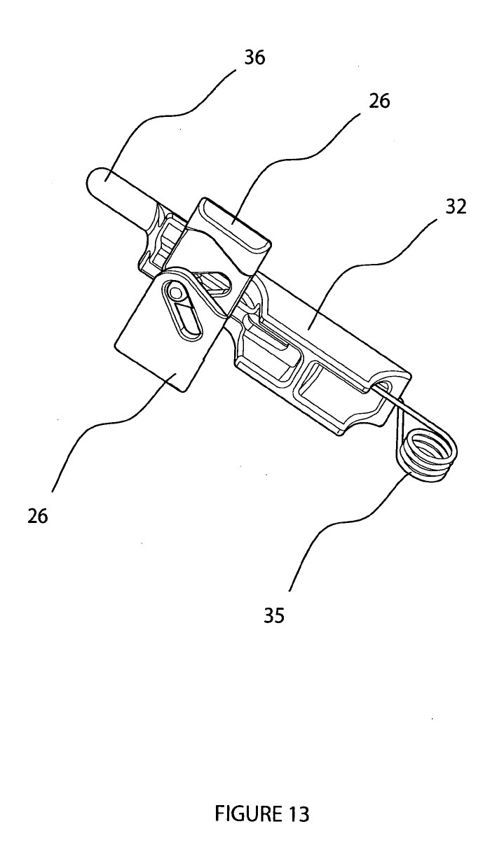

FIG. 13 is a partial lower perspective view of a spoke assembly locking mechanism,

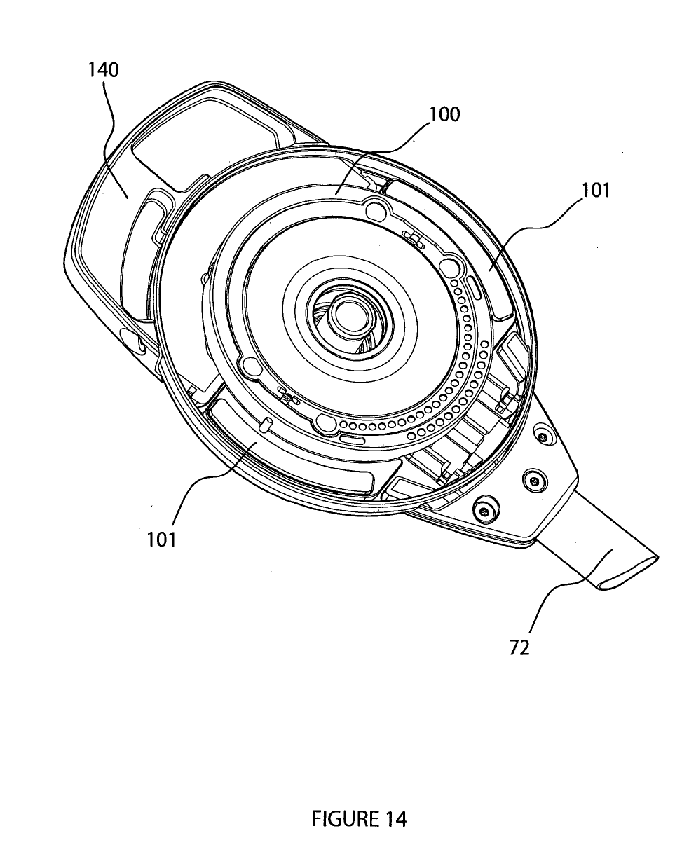

FIG. 14 is a partial perspective view of the lower arm assembly,

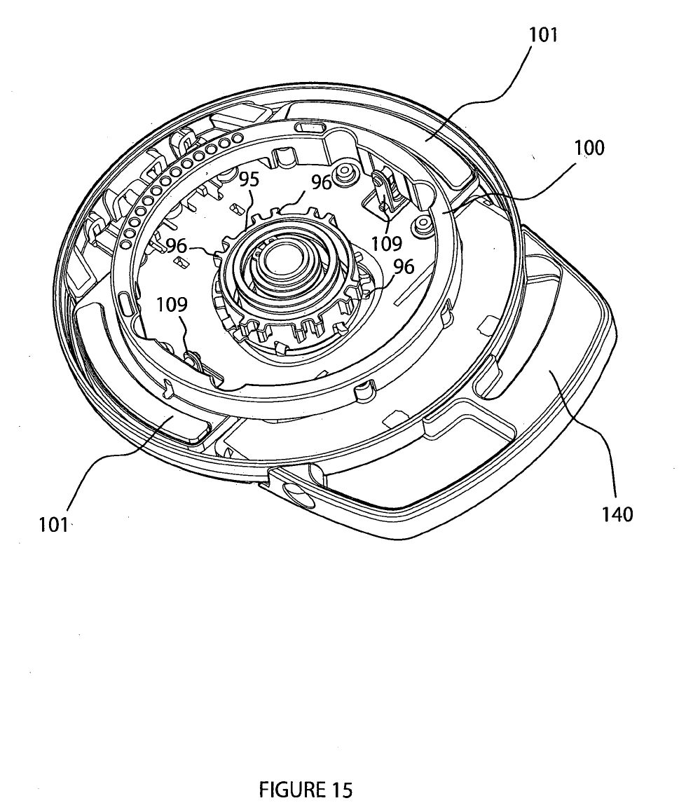

FIG. 15 is a partial perspective view of various components of the lever arm assembly,

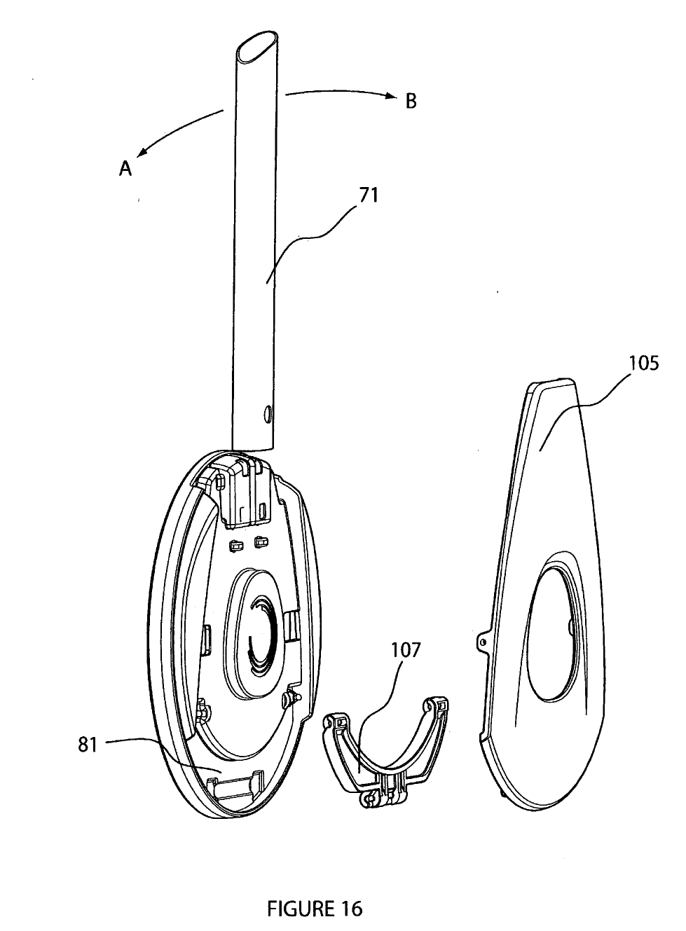

FIG. 16 is an exploded view of various components of the lever arm assembly,

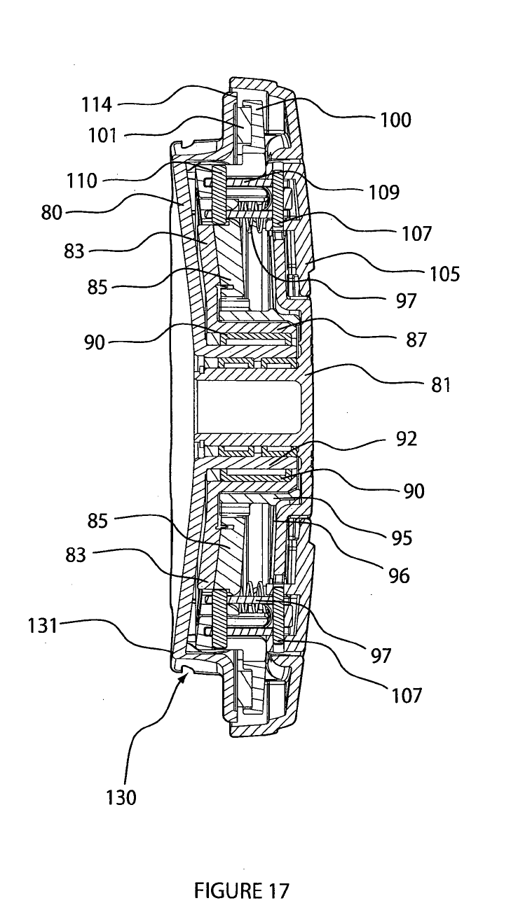

FIG. 17 is a cross-sectional view on X-X of the clutch and braking assembly,

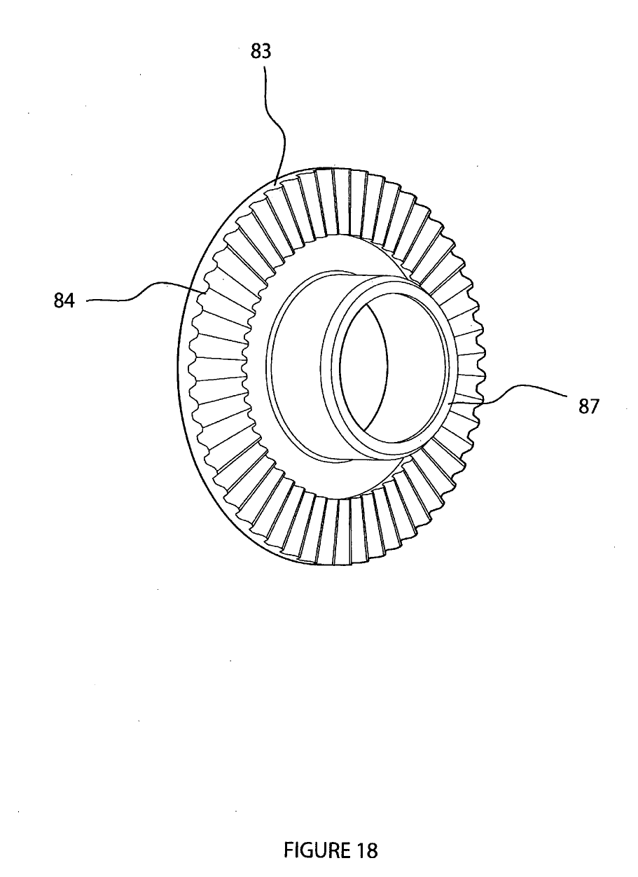

FIG. 18 is a perspective view of a first clutch plate, and

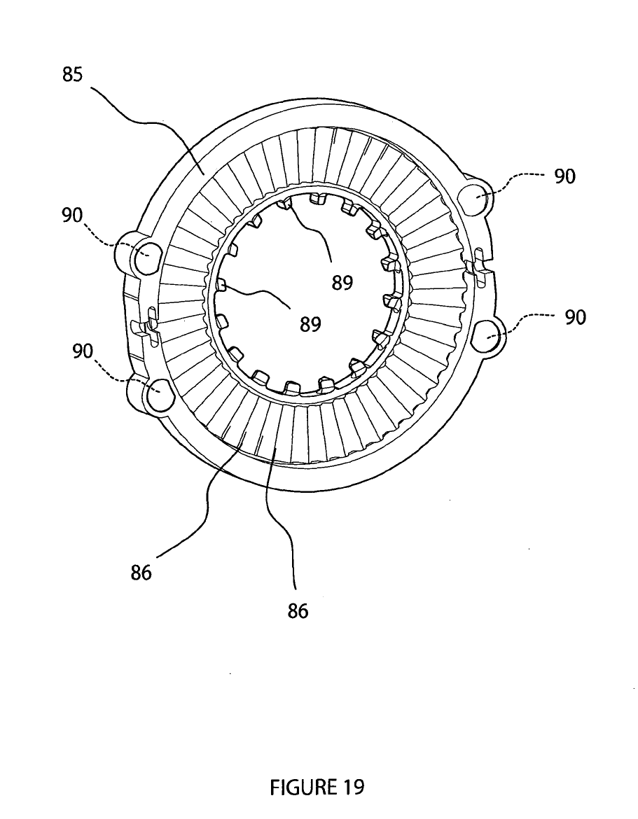

FIG. 19 is a perspective view of a second clutch plate.

With reference to FIGS. 1 and 2 there is shown a propulsion apparatus comprising a wheel adapter assembly 1 and a lever arm assembly 2. In use the wheel adapter 1 is releasably connectable to a rim 4 of a wheelchair wheel 3 (as shown in FIG. 3). The lever assembly 2 is releasable connectable to the wheel adapter assembly 2 so that a user of a wheelchair provided with two such propulsion apparatus, one on each wheel, can propel the wheelchair thereby. The lever arm assembly comprises a selectively engageable brake and drive assembly.

A detailed description of the wheel adapter 1 is first provided. Extending generally radially outwardly form the assembly there are provided three spoke assemblies 5 at the free end of each of which there is provided connection formations 6 which are adapted to engage with the rim 4.

A hub assembly comprises an outer housing 8 and an inner housing 7 which accommodate a cam ring 9, a latch release assembly 10 and a pinion 11. The latch release assembly 10 comprises a ring 12 and pivotable latch members 13.

The outer housing 8 and the inner housing 7 are each provided at respective radially inner peripheries with corresponding keying formations 15 and 16 respectively.

The method of attachment of the wheel adapter 1 to a wheelchair will now be described. The spoke assemblies 5 are arranged to be in a pivotable condition, that is a radially outer portion 20 is free to be pivoted towards and away from a yoke portion 21 (as best seen in FIG. 10). Each outer portion 20 is pivotally connected to a respective yoke portion 21 by way of end portions of a pin 22 which are received in respective apertures 23 of the yoke portion.

Each spoke is provided with a locking mechanism in which slidably mounted stops 26 of the outer portion 20 are receivable by apertures 25. In the pivotable condition the stops 26 are not received in the apertures 25 and so the outer portion is capable of being pivoted towards and away from the yoke portion.

In fitting the wheel adapter 1 the connector portions 6 are arranged to engage with the rim of a wheel. The outer housing 8 is then urged towards the wheel. In so doing the stops 26 are urged against cam surfaces 28 of the yoke portions 21 and thereby urging the stops inwardly. On becoming aligned with the apertures 25, the resilient biasing of the respective spring 29 (which is located in a recess 30 of the latch body 32 of the outer portion) which acts so as to urge the stops 26 outwardly. It will be appreciated that the latch body 32 is held to the outer portion by way of a headed pin 33, and this also allows the latch body 32 to be translationally moved within the recess 30. A spring member 35 resiliently biases the outer portion towards the yoke portion. One limb of the spring member 25 sits atop a surface 38 of the yoke portion and the other limb is received in the latch body 32.

Once all of the stops 26 are received in the respective apertures 25 the outer portions 20 are held in substantially rigid condition relative to the yoke portions 21. In order to release the wheel adapter from the wheel a release portion 36 of each latch body (which is received in recess 37) is urged generally radially inwardly so urging the stops 26 radially inwardly so that the outer portion can again then adopt a pivotable condition.

Each yoke portion 21 comprises a rib 40, each rib 40 being received in a cam track 50 which comprises three track portions 51 of varying radius. Accordingly a suitable tool can be used to rotate pinion 11 and so rotationally mesh with the circumferential teeth of the cam ring 9. By so doing the varying radius cam track portions urge the spoke assemblies 5 radially inwardly or radially outwardly (depending on the sense of rotation). It will be appreciated that channels 42 of the yoke portions 21 move along ribs 44 of the inner housing 7. Resiliently deflectable members 53 of the cam ring 9 maintain the spoke assemblies 5 at a chosen radial extent by virtue of engagement with teeth 60 (as best shown in FIG. 9) of the outer housing 80.

The various constructional features of the lever assembly 2 will now be described. The lever assembly 2 comprises a handle portion 70, a lever arm 71 and a hub portion (shown generally by the reference numeral 72). The hub portion 72 comprises a clutch and braking arrangement which is actuated by lateral movement of the lever arm 71.

The hub portion 72 comprises a lever base 80 which is provided with keying formations 81 which are adapted to be received by the keying arrangement 15 and 16 of the wheel adapter 1. The lever base housing 80 and a lever top housing 81 enclose the clutching and braking arrangement. Specifically, with reference to FIGS. 17, 18 and 19, there is provided a lower clutch plate 83 and an upper clutch plate 85. Opposing surfaces of the plates 83 and 85 are provided with engageable teeth, 84 and 86 respectively. The lower clutch plate 83 comprises an axle portion 87. The upper clutch plate 85 comprises radially inner cam teeth 89 and four radially outer blind recesses 90.

A radially inner surface of the axle portion is provided with a generally cylindrical roller or sprag clutch component 90 which comprises a plurality of resiliently biased rollers or sprags which engage with a cylindrical hub formation 92 of the lever base housing 80. The rollers or sprags are biased such as to allow rolling engagement of the rollers or sprags in the hub formation 92 in one rotational sense but not in the other. In the locked condition the rollers or sprags grip the hub formation 92 so as to rotationally drive the base housing 80 (and so drive the wheel).

A radially outer surface of the axle portion 87 is in rotational bearing contact with a clutch latch component 95 which is of generally hollow cylindrical form. The component 95 is provided with cam teeth 96 which are adapted to engage with cam teeth 89 of the upper clutch plate 85 so as to axially translate the upper clutch plate into and out of engagement with the lower clutch plate 83. It is to be noted that floating compression springs 97 (located in the blind recesses 90) resiliently bias the upper clutch plate 85 towards the lower clutch plate 83.

A brake mounting 100, of generally ring or annular form, carries two brake pads 101.

The lever arm 71 is attached to a lever cover 105. The lever cover 105 is attached to a pivotally mounted linkage 107, the linkage 107 being pivotally mounted to the lever top housing 81. The lever cover is also attached to pins 107. In turn the pins 107 are connected to a respective linkage 109, each of which carries at an opposite end a pin 110.

In use, by moving the lever arm 71 in the lateral direction A the pins 110 urge the brake mounting 100 towards the base housing 80 so as to bring the brake pads 101 into the frictional engagement with inner annular surface 114 of the base housing.

In the condition shown in FIG. 17 if a user where to urge the lever arm forward (ie generally in the direction of desired travel) the rollers of the roller clutch 90 would lock an so transmit a driving torque to the base housing 80 and onward to the wheel 3. On bringing the lever back (in a direction generally opposite to the direction of travel of the wheelchair) the rollers of the roller clutch will not be locked and are free to rotate on the hub formation 92 and so no torque is transmitted to the wheel.

If the user urges the lever handles in direction B, ie generally laterally outwards then the pins 110 will engage with the upper clutch plate 85 to bring said clutch plate out of engagement with the lower clutch plate. The arrangement of the teeth 96 of the component 95 ensure that the upper clutch plate is held in this condition, which may be termed a neutral condition. In the neutral condition the only way for the user to transmit torque to the wheels is to bring the lever arms generally inwardly so as to engage the brake and then mover the lever arms in the direction of desired travel.

In order to re-engage the clutch plates the user pushes the lever arms laterally outwards in direction B, and in so doing the cam teeth 96 and 89 engage so as to urge the clutch plate (with the assistance of the springs 97) back into engagement with the lower clutch plate 83. If an excessive force is applied to the lever arms whilst the clutch plates are in an engaged condition then the teeth 84 and 86 are configured to override.

The lever assembly 1 is attached to the wheel adapter by urging the base housing 80 into engagement with the keying formations of the wheel adapter. Once in position, portions 120 of the latch members 13 are resiliently biased by spring members 150 to be received in recesses 130 of the base housing 80. In order to remove the lever arm assembly from the wheel adapter the user urges the switches 125 of latch release 12 and so pivot the portions 120 out of locking engagement and at the same time ramp surface portions 122 engage with surface 131 of the base housing 80 to urge the lever assembly away from the wheel adapter.

The lever assembly is provided with a counterweight portion 140. In use this acts as a self-righting means which ensures that the lever arms are in a generally upright orientation when not gripped by the user.

The handle portion 70 may advantageously be adapted to be moveable along the lever arm 71 to one of a plurality of indexing positions so that a user can adjust the working length of the lever arm assembly.

1. A wheel adapter assembly comprising attachment means for attachment to a wheel or structure projecting from the wheel, the attachment means comprising a pivotable spoke assembly which is pivotable about an axis substantially perpendicular to the axis of rotation of the adapter assembly when secured to the wheel and further comprising locking means to a hold the spoke assembly substantially rigid with a hub portion.

2. A wheel adapter assembly as claimed in claim 1 comprising a plurality of angularly spaced spoke assemblies.

3. A wheel adapter assembly as claimed in claim 1 in which the or each spoke assembly is capable of being moved from a radially retracted condition to a radially extended condition and vice versa.

4. A wheel adapter assembly as claimed in claim 3 which comprises a cam arrangement which is engageable with the spoke assembly, and the cam arrangement is operable to adjust the radial position of the or each spoke assembly.

5. A wheel adapter assembly as claimed in claim 4 in which the cam arrangement comprises a cam track which is arranged to be operated by rotation thereof.

6. A drive and brake arrangement for a propulsion apparatus, the arrangement comprising clutch means which allows selective engagement of roller clutch means; in a first selected condition the roller clutch means transmits an input torque of a first rotational sense to an output drive portion and does not transmit an input torque of an opposite rotational sense to the output drive portion, and in a second selected condition the clutch means is disengaged.

7. A brake and drive arrangement as claimed in claim 6 in which the clutch means is selectively engageable with the output drive portion by way of relative translational movement.

8. A brake and drive arrangement comprising a resilient biasing arrangement which serves to resiliently bias the clutch means and the output drive portion, and a cam arrangement, and the clutch means is selectively engageable with the output drive portion by way of the action of the cam arrangement and the resilient biasing arrangement.

9. A brake and drive arrangement comprising a lever arm assembly.

10. A brake and drive arrangement as claimed in claim 6 comprising a weighted portion which, in use, acts to self-right the arrangement into a desired orientation.

11. Propulsion apparatus comprising the wheel adapter of claim 1 and a drive and brake arrangement including clutch means which allows selective engagement of roller clutch means such that in a first selected condition the roller clutch means transmits an input torque of a first rotational sense to an output drive portion and does not transmit an input torque of an opposite rotational sense to the output drive portion, and in a second selected condition the clutch means is disengaged.

12. Propulsion apparatus as claimed in claim 11 in which the drive and brake arrangement and the wheel adapter are detachably connectable.

13. A brake and drive arrangement as claimed in claim 8 comprising a weighted portion which, in use, acts to self-right the arrangement into a desired orientation.

14. A brake and drive arrangement as claimed in claim 9 comprising a weighted portion which, in use, acts to self-right the arrangement into a desired orientation.

15. Propulsion apparatus comprising the wheel adaptor of claim 1 and a brake and drive arrangement including a resilient biasing arrangement which serves to resiliently bias the clutch means and the output drive portion, and a cam arrangement, wherein the clutch means is selectively engageable with the output drive portion by way of the action of the cam arrangement and the resilient biasing arrangement.

16. Propulsion apparatus as claimed in claim 15 in which the drive and brake arrangement and the wheel adapter are detachably connectable.

17. Propulsion apparatus comprising the wheel adaptor of claim 1 and a brake and drive arrangement including a lever arm assembly.

18. Propulsion apparatus as claimed in claim 17 in which the drive and brake arrangement and the wheel adapter are detachably connectable.
